(19) United States
(12) Patent Application Publication
(10) Pub. No.: US 2025/0037893 A1
(43) Pub. Date: Jan. 30, 2025

(54) IMPROVED SYSTEM FOR SUPPORTING PACKAGING FOR TRANSPORTING RADIOACTIVE MATERIALS, CONFIGURED TO ALLOW IT TO PIVOT FROM A HORIZONTAL POSITION FOR TRANSPORT INTO A VERTICAL POSITION FOR USE

(71) Applicant: ORANO NUCLEAR PACKAGES AND SERVICES, MONTIGNY LE BRETONNEUX (FR)

(72) Inventors: Hervé RIPERT, PARIS (FR); Vincent RENARD, LE BOULLAY-THIERRY (FR); Thibault LAURENT, VERSAILLES (FR)

(21) Appl. No.: 18/716,568

(22) PCT Filed: Dec. 19, 2022
(86) PCT No.: PCT/FR2022/052415

§ 371 Date: Jun. 5, 2024

(30) Foreign Application Priority Data
Dec. 20, 2021 (FR) FR2114035

(51) Int. Cl. G21F 5/14

(52) U.S. Cl. CPC G21F 5/14

(57) ABSTRACT

A system for supporting packaging for transporting radioactive materials, configured to allow the packaging to be moved from a horizontal position for transport into a vertical position for use. The system includes: a support chassis; a first lateral support device for supporting a top end part of the packaging; a pivoting support system, mounted with the ability to pivot on the support chassis so as to be able to pivot with respect to same and with respect to the first lateral support device when the packaging is being tilted, the pivoting support system comprising: a second lateral support device for supporting a bottom end part of the packaging; and an axial support device for the bottom-end part of the packaging.

### TECHNICAL FIELD

The present invention relates to the field of transporting and storing radioactive materials. It relates more specifically to systems and methods used to tip packaging for transporting radioactive materials from a horizontal position for transport to a vertical position for use, the latter usually being required to carry out operations involving loading or unloading radioactive materials from the packaging.

### PRIOR ART

Packaging intended to contain radioactive materials is generally transported in the “supine” position, in which the longitudinal axis of the packaging is oriented horizontally.

When it is unloaded from the transport vehicle, the packaging is usually moved from its horizontal position to a vertical position, in order, for example, to then be loaded with or unloaded of the radioactive materials that it contains, in a dedicated facility.

In order to move it from the horizontal position for transport to the vertical position for use, there are solutions used to pivot the packaging around handling elements placed near the bottom of this packaging. These same handling elements are usually used to support the packaging on a frame in the horizontal position, and are then used as pivoting elements to move the packaging to the vertical position.

However, these pivoting solutions become ineffective when the packaging is not fitted with such handling elements, also known as handling pins.

A solution is therefore required that can be used to move the packaging from the horizontal position for transport to the vertical position for use without the use of handling pins arranged near the bottom of the packaging.

### DISCLOSURE OF THE INVENTION

The invention therefore aims to address the need identified above. To do this, the first object of the invention is a system for supporting packaging for transporting radioactive materials, the system being configured to allow the packaging to be moved from a horizontal position for transport to a vertical position for use, and vice versa.

According to the invention, the system includes:
a support frame;
a first lateral support device for supporting a head end part of the packaging when it is in a horizontal position for transport, the first lateral support device being mounted on the support frame;
a pivoting support system, pivotably mounted on the support frame so as to be able to pivot in relation to the latter and in relation to the first lateral support device when the packaging is tipped, the pivoting support system comprising:
a second lateral support device for supporting a bottom end part of the packaging when it is in a horizontal position for transport and when it is tipped; and
an axial support device for the bottom end part of the packaging, designed to take up the axial forces generated by the packaging when it is tipped.

Thanks to the use of the pivoting support system, cooperating with the bottom end part of the packaging, the invention provides a simple and effective solution enabling the packaging to be moved from the horizontal position for transport to the vertical position for use, and vice versa, without the use of handling pins arranged at this bottom end part of the packaging.

Moreover, while the second lateral support device is designed to pivot when the package is tipped, the first lateral support device remains stationary during this pivoting. This design reduces the weight and footprint of the pivoting support system, and makes it even easier to tip the packaging using the support system according to the invention.

Finally, by having the pivoting support system cooperate with the bottom end part of the packaging, it is possible to bring the pivot axis as close as possible to this bottom of the packaging, or even to have this pivot axis pass notionally through the bottom of the packaging. This advantageously reduces the amount of free space required below this axis to allow the packaging to be tipped.

The invention preferably has at least one of the following optional features, considered separately or in combination.

The second lateral support device preferably includes an arcuate beam fitted with support pads.

The axial support device is preferably designed to be removed from the pivoting support system. Nevertheless, a non-removable design remains conceivable without departing from the scope of the invention. The ability to remove the axial support device makes it possible to consider several different ways of placing the packaging on the support system according to the invention, for example by axially inserting the packaging into this support system. The removable nature of the axial support device also makes it possible to fit a rear shock-absorbing cover to the bottom end part of the packaging when it is in a horizontal position for transport.

The axial support device preferably includes a beam fitted with axial support means on the bottom end part of the packaging, these axial support means preferably comprising several actuators.

The first lateral support device preferably includes support pads mounted on the support frame.

The support system preferably includes means for locking the pivoting support system, locking it in a position which causes it to place the packaging in a vertical position. The pivoting support system preferably also includes removable clamping means, designed to press the bottom end part of the packaging against the second lateral support device. This could be one or more slings, for example made of textile material.

The support frame is preferably fitted with an axial stop device for the packaging, when it adopts its horizontal position for transport, the axial stop device comprising an axial stop member that is self-positioning relative to the packaging when the latter is placed on the support frame.

This axial stop member preferably has an upwardly tapering axial thickness.

The support frame is preferably fitted with lifting points and/or lashing points.

A pivot connection is preferably provided between the pivoting support system and the support frame at an axial end part of the support frame, this connection defining a pivot axis intended to notionally pass through said bottom end part of the packaging or even notionally pass through the bottom of the packaging.

Another object of the invention is an assembly comprising packaging for transporting radioactive materials, as well as a system for supporting packaging such as the one described above.

Another object of the invention is a vehicle for transporting radioactive materials fitted with such a system for supporting packaging, the vehicle comprising a platform on which the packaging support frame is fixed. This attachment of the support frame to the platform can be dismantled, particularly when the assembly formed by this frame and the packaging needs to be moved from the platform of the vehicle to the ground, or vice versa. Finally, another object of the invention is a method for moving packaging for transporting radioactive materials using such a system for supporting packaging, the method comprising the following steps:
placing the axial support device on the bottom end part of the packaging;
lifting and moving the packaging using at least one handling element attached to the head end part of the packaging, so as to cause the pivoting support system to pivot in relation to the support frame, until the packaging supported by the pivoting support system adopts a vertical position.

Other advantages and features of the invention will become apparent in the non-limiting detailed description below.

### BRIEF DESCRIPTION OF THE DRAWINGS

This description will be given with reference to the appended drawings wherein;

FIG. 1 shows a perspective view of a vehicle for transporting radioactive materials according to a preferred embodiment of the invention;

FIG. 2 shows a perspective view of part of the preceding figure, with the shock-absorber covers removed from the packaging;

FIG. 3 shows a perspective view of the system for supporting packaging shown in the preceding figures;

FIG. 4 shows a side view showing a step of a method for tipping the packaging using the support system shown in the preceding figure;

FIG. 5 shows a side view of a subsequent step of the tipping method;

FIG. 6 shows a perspective view of the second lateral support device for the packaging;

FIG. 7 shows a perspective view of the axial support device for the packaging;

FIG. 8 shows a perspective view of an axial stop device for the packaging in a first position;

FIG. 9 shows a perspective view of the same axial stop device in a second position;

FIG. 10 shows a sectional view of the axial stop device shown in FIGS. 8 and 9;

FIG. 11 shows a perspective view of part of the support system, showing means for locking the pivoting support system;

FIG. 12 shows a side view of a rear part of the support system;

FIG. 13 shows a perspective view of a rear part of the support system;

[FIG. 14]

[FIG. 15]

[FIG. 16]

FIG. 17 show side views showing a method for loading the packaging onto the support system.

### DESCRIPTION OF THE EMBODIMENTS

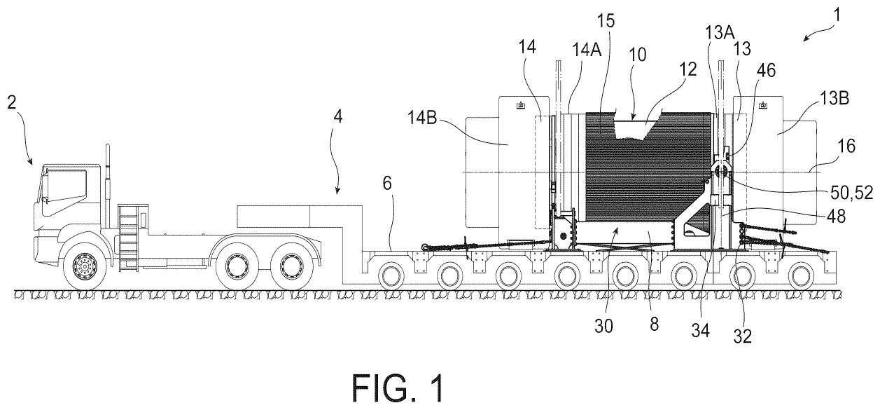

FIG. 1 first of all shows a vehicle 1 for transporting radioactive materials according to a preferred embodiment of the invention.

The vehicle 1 is a road transport vehicle here, but it could alternatively be a rail transport vehicle. It comprises a front traction unit 2 as well as a trailer 4 with a loading platform 6.

A system 30 for supporting packaging 10 for transporting radioactive materials is mounted on the platform. The attachment of the support system 30 to the platform 6 can preferably be dismantled, but alternatively, it could be achieved in a non-removable manner, for example by welding or equivalent means.

The packaging 10 is formed by a lateral body 12, a bottom 13 and a lid 14 sealing an opening of the packaging axially opposite the bottom. The packaging has a longitudinal central axis 16 centred relative to the lateral body 12, and passing through the lid and the bottom of this same packaging. As shown in FIG. 1, the lateral body 12 can be covered with cooling fins 15.

The packaging includes a bottom end part 13A, comprising the bottom 13 as well as an axial end of the lateral body 12 located on the side of this bottom. In a similar manner, the packaging includes a head end part 14A, comprising the lid 14 as well as an axial end of the lateral body 12 located on the side of this lid.

In FIG. 1, the packaging 10 is shown in a horizontal position for transport, also known as the “supine” position, in which its axis 16 is parallel to the platform 6 of the vehicle.

Moreover, the head end part 14A is oriented towards the front of the vehicle, although the opposite could be conceivable without departing from the scope of the invention.

Conventionally, the packaging 10 forms an outer envelope of a package and defines a cavity for housing radioactive materials, and possibly a storage basket. The radioactive materials can be, for example, waste containers, or preferably nuclear fuel assemblies.

At the two axial end parts 13A, 14A of the packaging 10, the latter comprises shock-absorber covers. These are a shock-absorber cover 14B at least partially covering the head end part 14A, axially and laterally, and a shock-absorber cover 13B at least partially covering the bottom end part 13A, also axially and laterally. These shock-absorber covers 13B, 14B help to maintain the integrity of the packaging in the event of a fall during transportation. However, during operations involving loading/unloading the radioactive materials from the packaging, these covers are usually removed.

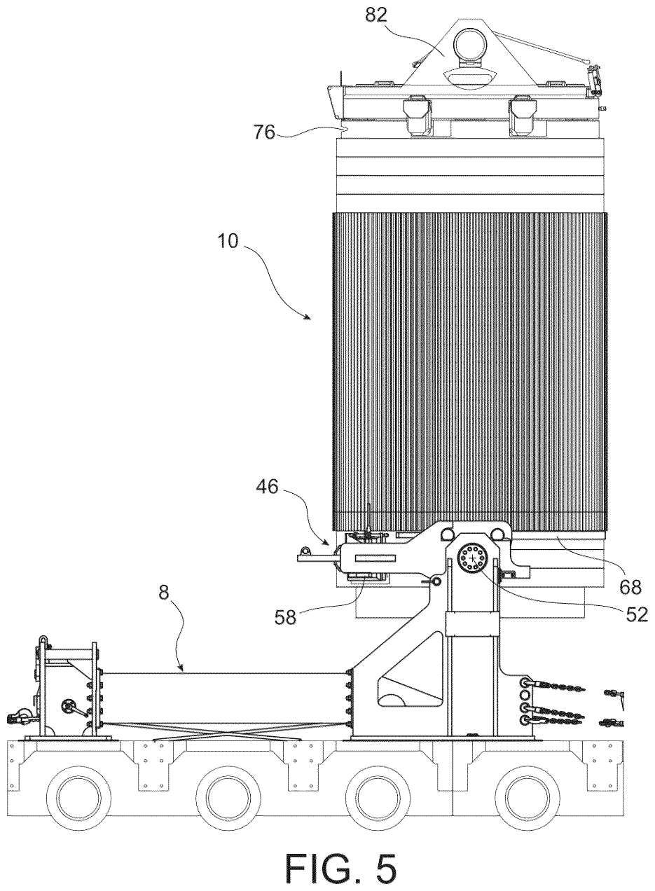

The support system 30, which is also the object of the invention, is configured to allow the packaging 10 to be moved from a horizontal position for transport shown in FIGS. 1, 2 and 4, to a vertical position for use shown in FIG. 5, and vice versa.

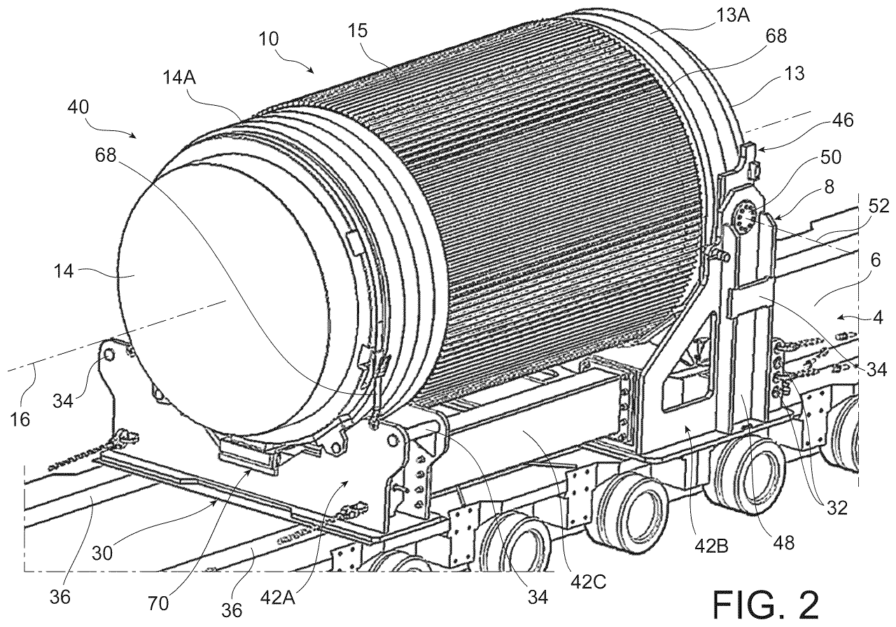

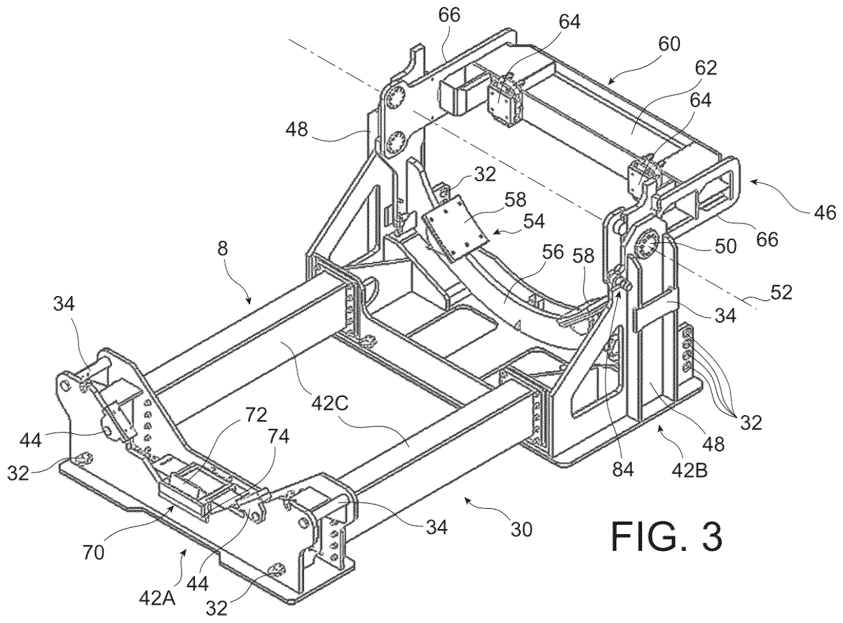

With reference now to FIGS. 1 and 2, and more specifically with reference to FIG. 3, the main components of the support system 30, which enables the packaging 10 to be tipped, will be described.

First of all, the system 30 includes a support frame 8, which is the part of the system 30 that is removably attached to the platform 6 of the vehicle. To do this, the frame 8 is equipped with lashing points 32 on the platform 6, these points 32 being in addition to the fixing of the frame 8 by conventional means to the platform, such as rails 36 shown in FIG. 2.

In addition to these lashing points, the frame 8 is equipped with lifting points, for example four lifting points 34 able to cooperate with slings and a hoisting beam (not shown), to enable handling of the support system 30 alone, or of the assembly 40 formed by this system 30 and by the packaging resting thereon, horizontally.

The support frame 8 is preferably made up of several separate parts fitted together, for example by bolting and/or welding.

First of all, there is a front part 42A designed to carry a first lateral support device 44 for the packaging, which will be described below. There is also a rear part 42B designed to carry a pivoting support system 46 for the packaging, which will also be set out in detail below. Finally, an intermediate part 42C in the form of beams links the front and rear parts of the frame 8.

The first lateral support device 44 is therefore carried by the front part 42A of the frame 8, and it is designed to support the head end part 14A of the packaging when it is in a horizontal position for transport. It preferably includes several support pads 44 mounted on the frame 8, for example enabling an angular displacement of several degrees relative to this frame, of around +/−3°. In the preferred embodiment shown, two support pads 44 are provided, facing each other and each inclined, for example, by a value of approximately 45° to a horizontal plane.

The pivoting support system 46 for its part has a design specific to the invention, and which will be described with reference to FIGS. 1 to 7.

The pivoting support system 46 is pivotably mounted on a top end of vertical uprights 48 of the rear part 42B of the frame 8. The objective is to ensure that the entire system 46 can pivot in relation to the frame 8, and in relation to the head support pads 44 when the packaging is tipped.

To do this, a pivot connection 50 is provided between the pivoting support system 46 and the two uprights 48 of the frame 8. This pivot connection 50 is therefore located at a rear axial end part of the support frame 8, and it defines a pivot axis 52 notionally passing through the bottom end part 13A of the packaging, for example notionally passing through the bottom 13. The pivot axis 52 is also referred to as the tipping axis of the packaging. Thanks to this design, the packaging 10 can be easily tipped to its vertical position, without the need for any substantial vertical clearance between the pivot axis 52 and the base of the frame 8/the platform 6. As a result, the overall footprint and weight of the system are advantageously reduced. Indeed, this design provides a simple and appropriate solution to the problem of potential mechanical interference between the bottom end part 13A and the pivoting system 46 on the one hand, and the frame 8/the platform 6 on the other hand when the packaging 10 is tipped to its vertical position.

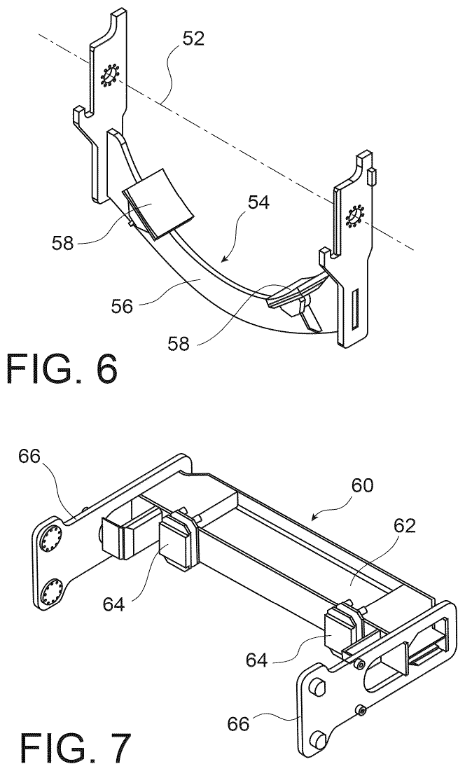

The pivoting support system 46 is substantially made up of two parts, preferably removably assembled one on top of the other. There is first of all a second lateral support device 54 provided to support the bottom end part 13A of the packaging when it is in a horizontal position for transport and also during operations involving tipping this same packaging. The second lateral support device 54, which can be seen in more detail in FIGS. 3 and 6, includes an arcuate beam 56 forming a cradle and arranged in a plane orthogonal to the axis 16. The beam 56 for its part carries rear support pads 58, for example two pads 58. The rear support pads 58 are mounted on the arcuate beam 56, for example enabling an angular displacement of several degrees, of around +/−3°. In the preferred embodiment shown, two rear support pads 58 are provided, facing each other and each inclined, for example, by a value of approximately 45° to a horizontal plane.

It should be noted that it is at the two opposite ends of the arcuate beam 56 that the aforementioned pivot connection 50 is located, so as to form two half-connections aligned along the pivot axis 52.

The pivoting support system 46 also includes an axial support device 60 for the bottom end part 13A of the packaging, this device 60 being removably assembled on the second lateral support device 54. Indeed, this axial support device 60 is designed to support the bottom end part 13A of the packaging so as to take up the axial forces generated by this packaging when it is tipped. In this way, in the transport configuration when the packaging 10 is equipped with its shock-absorber covers 13B, 14B, the axial support device 60 cannot cooperate with the bottom end part 13A covered by the shock-absorber cover 13B. The axial support device 60 is therefore not shown in FIG. 1 or in FIG. 2 showing the assembly 40 just after the shock-absorber covers have been removed.

The axial support device 60 includes a beam 62, preferably straight and oriented orthogonally to the axis 16. This beam 62 is fitted with axial support means on the bottom end part 13A of the packaging. More specifically, there are several axially oriented actuators 64, for example two actuators each including a support head designed to come into axial contact with the outer surface of the bottom 13.

Two lateral arms 66 respectively connect the two ends of the beam 62 to the two opposite ends of the arcuate beam 56, creating a general U shape for the removable axial support device 60.

In the horizontal position for transport, the packaging thus rests laterally on the support pads 44, 58. To secure this position, the system 30 can integrate slings 68, preferably made of textile material, in order to press the packaging lateral body against the front and rear support pads 44, 58. As shown in FIG. 2, the sling 68 at the front surrounds the head end part 14A, and its ends are fixed to the front part 42A of the frame 8. On the other hand, the sling 68 at the rear surrounds the bottom end part 13A, and its ends are fixed to the uprights 48 of the rear part 42B of the frame 8.

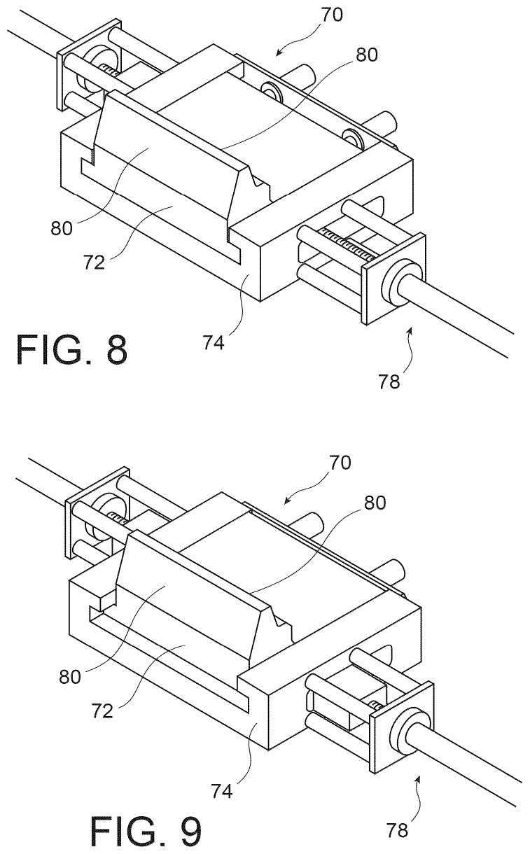

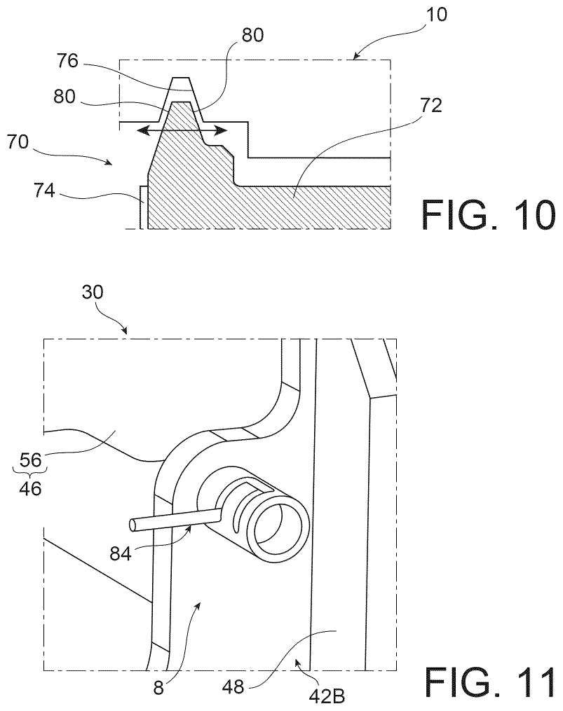

With reference now to FIGS. 2, 3 and 8 to 10, it should be noted that the frame 8 can be fitted with an axial stop device 70 for the packaging, when it adopts its horizontal position for transport. This device 70 is located on the front part 42A of the frame, between the two front support pads 44. It comprises an axial stop member 72 which can either be held floating axially in relation to a fixed base 74, or locked in an axial position on this same base. This design gives the axial stop member 72 the ability to self-position relative to the packaging 10 when the latter is placed on the support frame. Indeed, during this radial movement of the packaging held in a horizontal position, the latter has a holding groove 76 into which the axial stop member 72 is progressively inserted. As it is inserted, the floating axial stop member 72 becomes axially self-positioning as a result of the form fit between this member 72 and the groove 76 provided around the head end part 14A. Once insertion is complete and the packaging has been positioned on its support pads 44, 58, the stop member 72 can be locked in position, and thus act as an axial restraint for the packaging as it is transported. Appropriate control means 78 are used to control the locking and unlocking of the axial stop member 72, the two extreme axial positions of which have been respectively shown in FIGS. 8 and 9.

In order to facilitate the self-positioning of the axial stop member 72 relative to the groove 76 of the packaging, this member 72 has an upwardly tapering axial thickness. For example, two opposing inclined planes 80 are used to obtain the upwardly tapering axial thickness of the wedge-shaped member 72, as shown in the figures.

An operation involving tipping the packaging 10 using the support system 30 will now be described. Before this description, it should be noted that the system 30 could be arranged on the ground or on any platform other than that of a transport vehicle without departing from the scope of the invention.

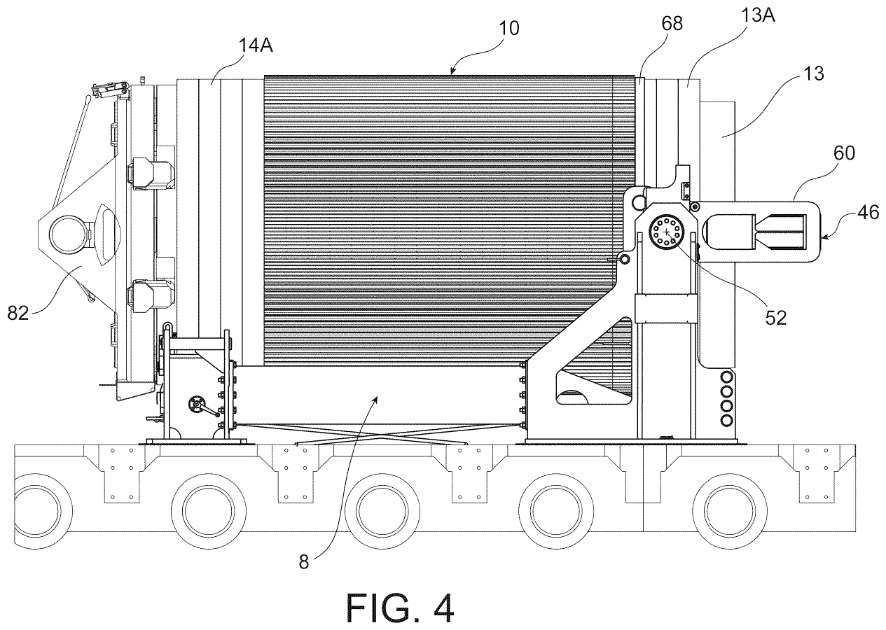

With reference to FIGS. 4 and 5, a method is described for moving the packaging 10 from the horizontal position for transport shown in FIG. 4 to the vertical position for use shown in FIG. 5.

First of all, the axial support device 60 is placed on the bottom end part 13A of the packaging 10 after the shock-absorber cover has been removed. The actuators are then activated to come into contact with the bottom 13A. In addition, one or more handling members 82 are mounted on the head end part 14A, like lifting lugs shown in FIG. 4. These lifting lugs 82 then cooperate with a lifting bridge (not shown) or any similar system to lift the head end part 14A. When this part 14A is lifted, the packaging 10 is tipped by pivoting about the axis 52, due to the pivoting of the pivoting support system 46 relative to the frame 8. During this tipping, the first lateral support device 44 remains fixed to the frame 8, and the inclined planes of the axial stop member allow easy extraction from the groove provided on the lateral body of the packaging. Tipping takes place over an angular range of approximately 90° around the axis 52 until the packaging 10, supported by the pivoting support system 46, adopts the vertical position shown in FIG. 5.

Finally, the packaging 10 can be released from the pivoting system 46 by removing the rear clamping sling 68, and then placed vertically on the floor, or in a dedicated facility, for example a facility where the radioactive materials can be loaded or unloaded. The handling members 82 can then be released from the packaging 10 to be replaced by specific handling members designed for operations involving loading or unloading the radioactive materials under water.

FIG. 11 shows that the support system 30 includes means 84 for locking the pivoting support system 46, locking it in a position which causes it to place the packaging in a vertical position. More specifically, this locking means 84 corresponds to a type of retractable finger carried by the frame 8, and which, in a protruding position, cooperates with the arcuate beam 56 of the second lateral support device, in order to maintain this beam 56 in a horizontal plane relative to the frame.

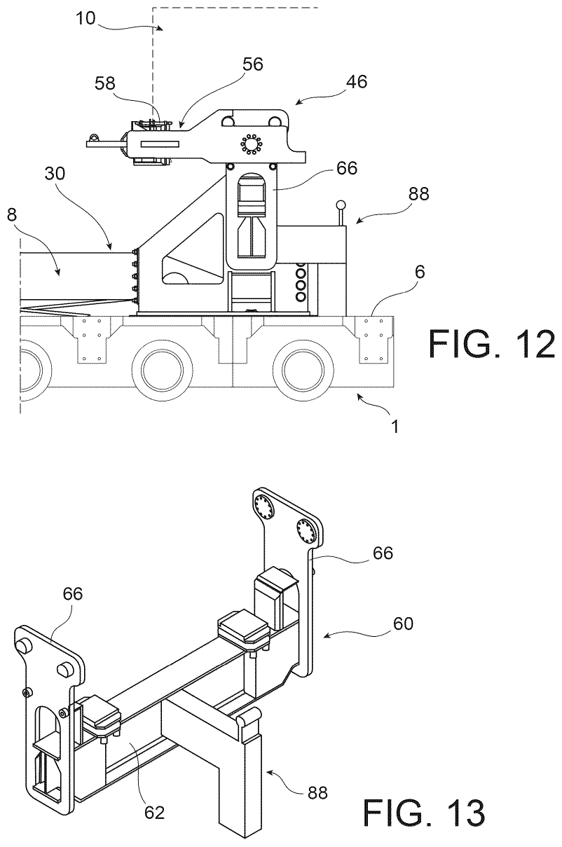

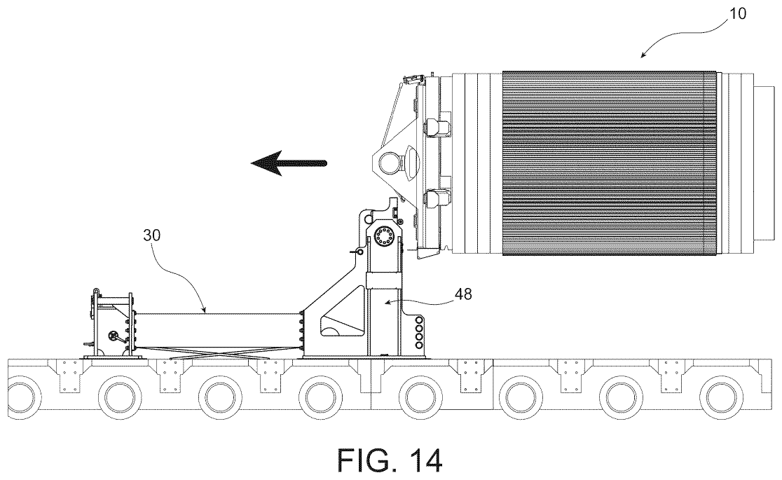

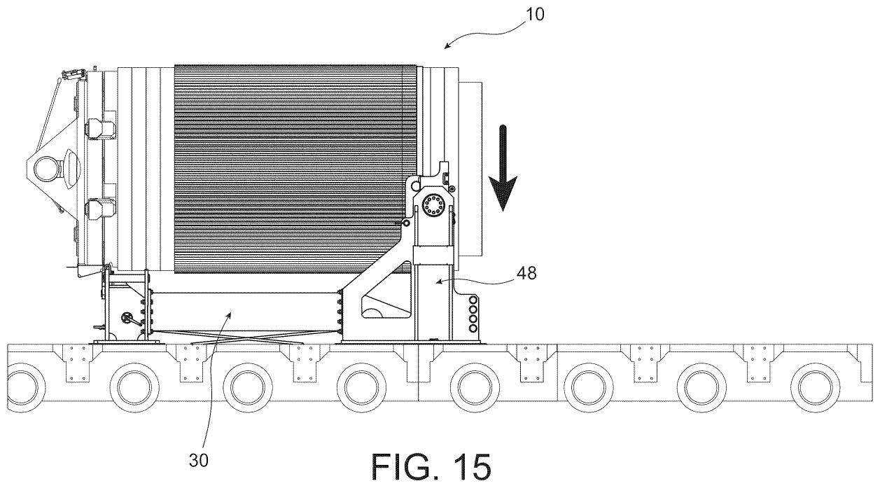

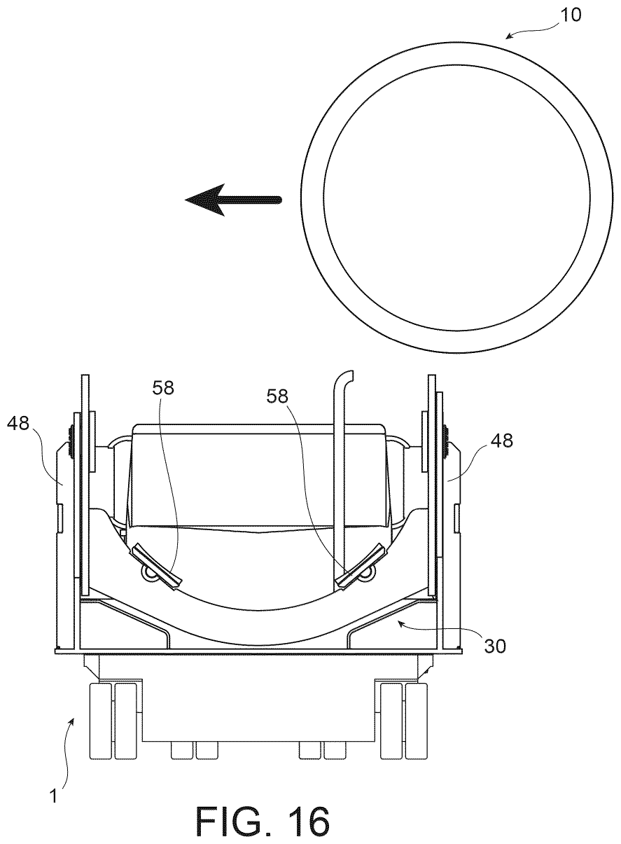

In a similar manner, FIGS. 12 and 13 show a stop system 88 which is attached to the beam 62, and which prevents the packaging 10 from tipping suddenly in a direction opposite to that intended to bring it into a horizontal position for transport. The stop system 88 includes an arm which bears against the platform 6 of the vehicle, which prevents the packaging from tipping in the unwanted direction, if it has been forgotten to lock the pivoting system 46 with the aforementioned means 84.

It should be noted that the packaging 10 can be loaded onto the support system 30 by tipping by carrying out the operations mentioned above, but in reverse order. However, other loading methods are possible with the support system according to the invention, without requiring the packaging to be tipped, and therefore by moving the packaging while keeping it in a horizontal position. As part of these operations, the packaging is handled using a slinging system not shown in the figures.

FIGS. 14 and 15 firstly show a method for axially loading the packaging 10 onto the support system 30. When the axial support device is removed, the packaging can effectively be inserted axially into the system 30, from the rear and partially between the two uprights 48, as shown by the arrow in FIG. 14. Then it simply needs to be lowered slightly to ensure that the packaging lateral body rests on the support pads.

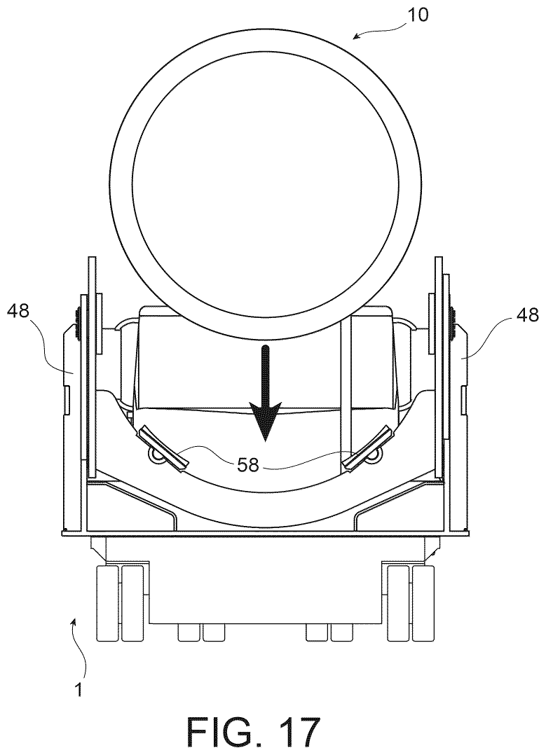

FIGS. 16 and 17 for their part show a method for laterally loading the packaging 10 onto the support system 30. The packaging is first of all moved sideways so that it is above the support system 30, as shown by the arrow in FIG. 16. The packaging 10 which is still held in a horizontal position is then lowered until it makes contact with the support pads.

Of course, various modifications can be made by a person skilled in the art to the invention that has just been described, only as non-limiting examples, and within the limit of the scope defined by the appended claims.

What is claimed is:

1. A system for supporting packaging for transporting radioactive materials, the system being configured to allow the packaging to be moved from a horizontal position for transport to a vertical position for use, and vice versa, the system comprising:
a support frame;
a first lateral support device for supporting a head end part of the packaging when it is in a horizontal position for transport, the first lateral support device being mounted on the support frame;
a pivoting support system, pivotably mounted on the support frame so as to be able to pivot in relation to the latter and in relation to the first lateral support device when the packaging is tipped, the pivoting support system comprising:
a second lateral support device for supporting a bottom end part of the packaging when it is in a horizontal position for transport and when it is tipped; and
an axial support device for the bottom end part of the packaging, designed to take up the axial forces generated by the packaging when it is tipped.

2. The system for supporting packaging according to claim 1, wherein the second lateral support device includes an arcuate beam fitted with support pads.

3. The system for supporting packaging according to claim 1, wherein the axial support device is designed to be removed from the pivoting support system.

4. The system for supporting packaging according to claim 1, wherein the axial support device includes a beam fitted with axial support means on the bottom end part of the packaging.

5. The system for supporting packaging according to claim 4, wherein the axial support means comprise one or more actuators.

6. The system for supporting packaging according to claim 1, wherein the first lateral support device includes support pads mounted on the support frame.

7. The system for supporting packaging according to claim 1, further comprising means for locking the pivoting support system, in a position which causes the packaging to be placed in a vertical position.

8. The system for supporting packaging according to claim 1, wherein the pivoting support system also includes removable clamping means, designed to press the bottom end part of the packaging against the second lateral support device.

9. The system for supporting packaging according to claim 1, wherein the support frame is fitted with an axial stop device for the packaging, when it adopts its horizontal position for transport, the axial stop device comprising an axial stop member that is self-positioning relative to the packaging when the latter is placed on the support frame.

10. The system for supporting packaging according to claim 9, wherein the axial stop member has an upwardly tapering axial thickness.

11. The system for supporting packaging according to claim 1, wherein the support frame is fitted with lifting points and/or lashing points.

12. The system for supporting packaging according to claim 1, wherein a pivot connection is provided between the pivoting support system and the support frame at an axial end part of the support frame, this connection defining a pivot axis intended to notionally pass through said bottom end part of the packaging or even notionally pass through the bottom of the packaging.

13. An assembly comprising packaging for transporting radioactive materials, as well as the system for supporting packaging according to claim 1.

14. A vehicle for transporting radioactive materials fitted with the system for supporting packaging according to claim 1, the vehicle comprising a platform on which the packaging support frame is fixed.

15. A method for moving packaging for transporting radioactive materials using the system for supporting packaging according to claim 1, the method comprising the following steps:
placing the axial support device on the bottom end part of the packaging; and
lifting and moving the packaging using at least one handling element attached to the head end part of the packaging, so as to cause the pivoting support system to pivot in relation to the support frame, until the packaging supported by the pivoting support system adopts a vertical position.
